(19) United States
(12) Patent Application Publication
(10) Pub. No.: US 2022/0192930 A1
(43) Pub. Date: Jun. 23, 2022

(54) INFANT PACIFIER

(71) Applicant: AMY BAUER, HENDERSON, NV (US)

(72) Inventor: AMY BAUER, HENDERSON, NV (US)

(21) Appl. No.: 17/555,352

(22) Filed: Dec. 17, 2021

Related U.S. Application Data
(60) Provisional application No. 63/127,149, filed on Dec. 18, 2020.

(51) Int. Cl. A61J 17/00; A61J 11/00; A61J 9/06; A61J 9/08

(52) U.S. Cl. CPC A61J 17/001; A61J 17/111; A61J 11/005; A61J 11/0055; A61J 9/085; A61J 9/0607; A61J 9/0623; A61J 9/0669; A61J 9/0684; A61J 11/006

(57) ABSTRACT

An anatomically emulating infant pacifier for a sucking infant's mouth has a substantially spherical silicone ball member with a hollow interior portion or cavity that may be designed to hold a gas or a liquid. A substantially circular, areola emulating, portion is disposed on the silicone ball member with a plurality of protrusions disposed therein. A nipple member centers the areola emulating portion, protruding perpendicularly from the areola emulating portion at a distal end of the nipple emulating member. The proximal end of the nipple emulating member, which may have at least one hole disposed therethrough, has a diameter substantially equivalent from the distal end, the middle portion of the nipple member narrower than the distal and proximal ends. The hollow interior portion of the silicone ball member is designed to equalize to the prevalent gas or air pressure, the silicone ball member designed to be squeezable by the baby to emulate a human breast.

### CLAIM OF PRIORITY

This application claims priority to and the benefit of U.S. Provisional Application with Ser. No. 63/127,149, with the same title, and filed on Dec. 18, 2020, the contents of which is hereby incorporated by reference in its entirety.

### FIELD OF THE INVENTION

The inventive concept relates generally to an infant pacifier.

### BACKGROUND

A pacifier is a rubber, plastic, or silicone nipple substitute given to an infant to suckle upon between feedings to quiet its distress by satisfying the need to suck when it does not need to eat. Pacifiers normally have three parts, an elongated teat, a mouth shield, and a handle. The mouth shield is large enough to prevent the child from attempting to take the pacifier into its mouth, and so forecloses the danger that the child will swallow then choke on it.

Currently, there are a number of solutions for pacifiers. One of these solutions attempts to utilize a one-piece pacifier, but this solution fails to meet the needs of the market because such pacifiers can be uncomfortable for the baby. Another solution attempts to utilize a stuffed animal pacifier, but this solution is similarly unable to meet the needs of the market because such pacifiers are cumbersome. Still another solution seeks to use a feeding pacifier, but this solution also fails to meet market needs because feeding pacifiers often get dirty. Therefore, there currently exists a need in the market for an improved pacifier.

### SUMMARY OF THE INVENTION

An anatomically emulating infant pacifier for a sucking infant's mouth has a substantially spherical, silicone ball member with a substantially hollow interior portion. A substantially circular, areola emulating, portion is disposed on the silicone ball member with a plurality of protrusion members emulating sebaceous glands disposed within the substantially circular, areola emulating portion. A nipple emulating member substantially centers the substantially circular, areola emulating portion, the substantially cylindrical nipple emulating member protruding substantially perpendicularly from the substantially circular, areola emulating portion at a distal end of the nipple emulating member, the proximal end of the nipple emulating member having a diameter substantially equivalent from the distal end of the nipple emulating member, the middle portion of the nipple emulating member narrower than the distal and proximal ends of the nipple emulating member. The hollow interior portion of the silicone ball member is designed to equalize to the prevalent air pressure, the silicone ball member designed to be substantially squeezable by the baby to emulate a human breast.

In one embodiment of the anatomically emulating infant pacifier for a sucking baby's mouth, the substantially spherical, silicone ball member is laterally divided at a middle portion of the substantially spherical, silicone ball member substantially coplanar to the substantially circular, areola emulating, portion, an upper portion of the silicone ball member bearing the substantially circular, areola emulating, portion coupled at the middle portion of the substantially spherical, silicone ball member to a lower portion of the silicone ball member by an upper helically threaded, plastic connector assembly and a lower helically threaded, plastic connector assembly, the upper and lower helically threaded plastic connector assemblies contiguously coupled to respective upper and lower edge portions of the middle portion of the spherical, silicone ball member, with corresponding groove portions and ridge portions of the helically threaded, plastic connector assemblies, when in a coupled state, substantially contiguously meshed. A stand assembly is coupled to a base of the lower portion of the silicone ball member. In one embodiment, the stand assembly is substantially cylindrical and may be a suction cup. In one embodiment, the stand assembly is substantially cylindrical, and a right-side handle member and a left-side handle member are couple to the lower helically threaded, plastic connector assembly. At least one hole member is disposed through the proximal end of the nipple portion, the silicone ball member designed to hold and dispense a liquid through the proximal end of the nipple portion.

In one embodiment of the anatomically emulating infant pacifier for a sucking baby's mouth, a loop protrusion member is disposed on the silicone ball member substantially opposite of the cylindrical nipple emulating member.

It would be advantageous to have an anatomically emulating infant pacifier for a sucking baby's mouth that is reusable. Furthermore, it would be advantageous to have an anatomically emulating infant pacifier for a sucking baby's mouth that is made of silicone. Still further, it would be advantageous to have an anatomically emulating infant pacifier for a sucking baby's mouth that is handheld.

The inventive concept advantageously fills the aforementioned deficiencies by providing an infant pacifier, which provides a natural feeling teething toy.

The anatomically emulating infant pacifier for a sucking baby's mouth is a natural feeling infant pacifier.

The anatomically emulating infant pacifier for a sucking baby's mouth has a silicone nipple. It is also an advantage for mothers to use the inventive concept when children start to bite when nursing, and is further useful, therefore, to ensure children are optimally fed even under circumstances where mothers might be reticent to breastfeed their children naturally. The anatomically emulating infant pacifier for a sucking baby's mouth may have a clip-on loop.

The anatomically emulating infant pacifier for a sucking baby's mouth fulfills the need for a baby pacifier.

Among other things, it is an advantage of the anatomically emulating infant pacifier for a sucking baby's mouth to provide an infant pacifier that does not suffer from any of the problems or deficiencies associated with prior solutions.

It is still further an advantage of the anatomically emulating infant pacifier for a sucking baby's mouth to be durable.

Still further, the anatomically emulating infant pacifier for a sucking baby's mouth may, in some embodiments, have a bottle attachment.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a front view of an infant pacifier.

FIG. 2 illustrates a top perspective view of the infant pacifier.

FIG. 3 illustrates a front view of a dividable infant feeding bottle with a cover and handles.

FIG. 4 illustrates a side view of the dividable infant feeding bottle and a handle.

FIG. 5 illustrates a top perspective view of the dividable infant feeding bottle.

FIG. 6 illustrates an exploded view of the infant feeding bottle.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

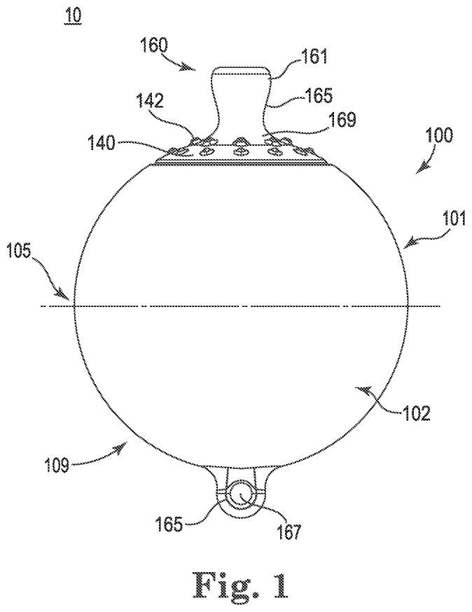

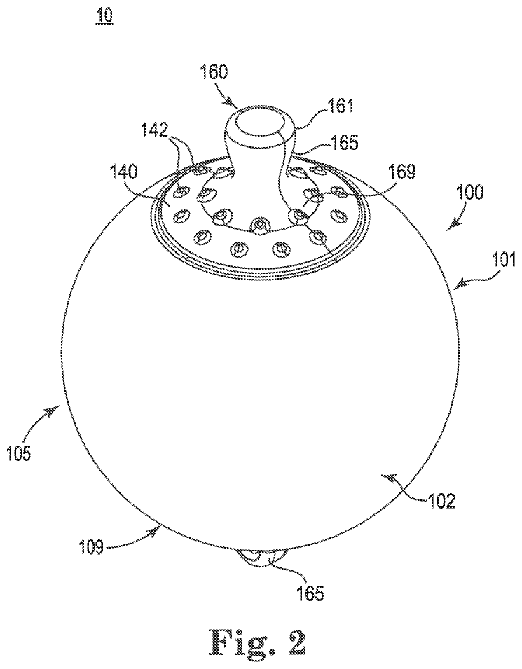

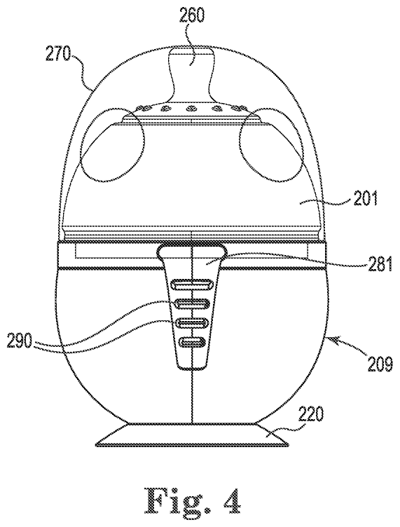

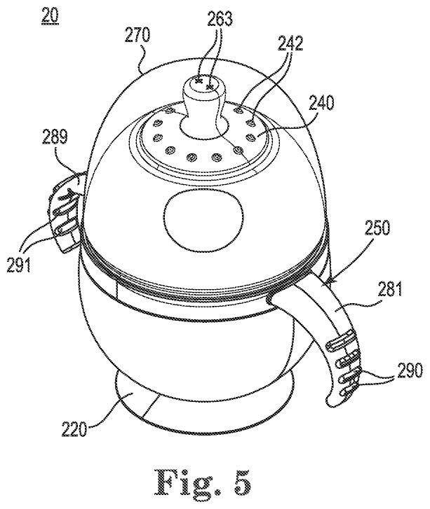

Referring to the figures, FIGS. 1-6 illustrate an anatomically emulating infant pacifier 10 for a sucking infant or baby's mouth that has a substantially spherical, silicone ball member 100 with a substantially hollow interior portion or cavity 102. A substantially circular, areola emulating, portion 140 is disposed on the silicone ball member 100 with a plurality of protrusion members 142 emulating sebaceous glands disposed within the substantially circular, areola emulating portion 140. A nipple emulating member 160 substantially centers the substantially circular, areola emulating portion 140, the substantially cylindrical nipple emulating member 160 protruding substantially perpendicularly or longitudinally from the substantially circular, areola emulating portion 140 at a distal end 169 of the nipple emulating member 160, the proximal end 161 of the nipple emulating member 160 having a diameter substantially equivalent from the distal end 169 of the nipple emulating member 160, the middle portion 165 of the nipple emulating member 160 narrower than the distal 169 and proximal 161 ends of the nipple emulating member 160, the nipple-emulating member has a substantial hourglass configuration. The hollow interior portion 102 of the silicone ball member 100 is designed to equalize to the prevalent air pressure, the silicone ball member 100 being designed to be substantially squeezable by the baby to emulate a human breast.

In one embodiment of the anatomically emulating infant pacifier 10 for a sucking baby's mouth, a loop protrusion member 165 is disposed on the silicone ball member 100 laterally from or substantially opposite of the cylindrical nipple emulating member 140, the loop protrusion member facilitates temporary fastening of infant pacifier to one of an infant or a caregiver. Protrusion member has an aperture 167 for coupling to a tether or string to attach to infant or caregiver.

In one example embodiment, the at least one of the silicone ball member, nipple member or areola emulating portion of the infant pacifier 10 is impregnated with an antimicrobial substance. In a related embodiment, the silicone ball member includes a plurality of textured frictional elements disposed on a surface to enhance gripping by the infant, the frictional elements consisting of but not limited to a plurality of fins, a plurality of nubs, and a plurality of microparticles embedded in the silicone material.

In a related embodiment, an anatomically emulating infant pacifier for a sucking infant's mouth including a substantially spherical, silicone ball member with a hollow interior portion or cavity, wherein the cavity is filled with a predetermined amount of one of either a gas or liquid and is hermetically sealed to retain the gas or liquid. The pacifier includes a substantially circular, areola emulating, portion disposed or formed on the silicone ball member, the areola-emulating portion including a plurality of protrusion members disposed within the substantially circular, areola emulating portion. The pacifier further includes a nipple emulating member substantially centering the substantially circular, areola emulating portion and having proximal and distal ends, the nipple emulating member having a substantially cylindrical configuration with the distal end coupled to and protruding longitudinally up from the areola emulating portion, such that the hollow interior portion of the silicone ball member is adapted to equalize to a prevalent gas pressure such that the silicone ball member is squeezable by the infant to emulate the feel of a human breast. In this example embodiment, the pacifier uses air as a gas and can use water or saline as a fluid to emulate the feel of the human breast.

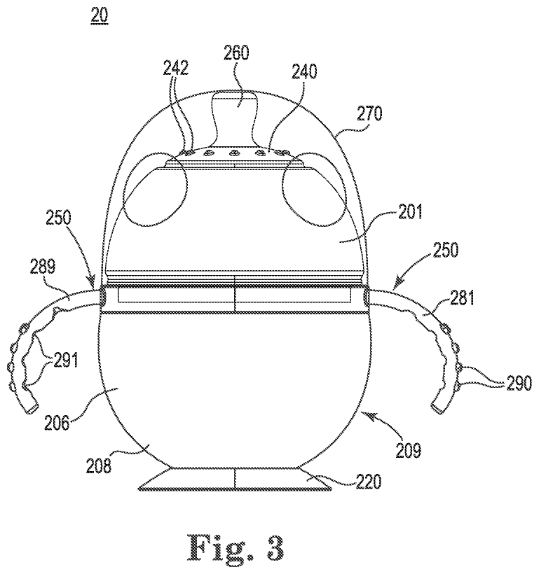

Referring now to FIGS. 3-6, in one embodiment of the anatomically emulating infant bottle 20 for a sucking infant, the substantially spherical, spherical two-member ball member 200 is laterally divided at a middle portion 205 of the substantially spherical ball member 200 substantially coplanar to the substantially circular, areola emulating portion 240, comprised of an upper ball portion 201 of the spherical ball member 200 bearing the substantially circular, areola emulating portion 240 coupled at the middle portion 205 of the substantially spherical, ball member 200 to a lower ball portion 209 of the ball member 209. In this example embodiment, upper ball portion 201 and lower ball portion 209 are coupled or joined by an upper helically threaded, plastic connector assembly 231 and a lower helically threaded, plastic connector assembly 239. In this example embodiment, upper ball member 201 is formed from BPA approved silicone while lower ball member 209 is formed from plastic, with the upper and lower helically threaded plastic connector assemblies 231, 239 contiguously coupled to a respective upper edge portion 204 and lower edge portion 206 of the middle portion 205 of the spherical, silicone ball member 205, with corresponding groove portions 232 and ridge portions 238 of the upper and lower helically threaded, plastic connector assemblies 231, 239, when in a coupled state, substantially contiguously meshed.

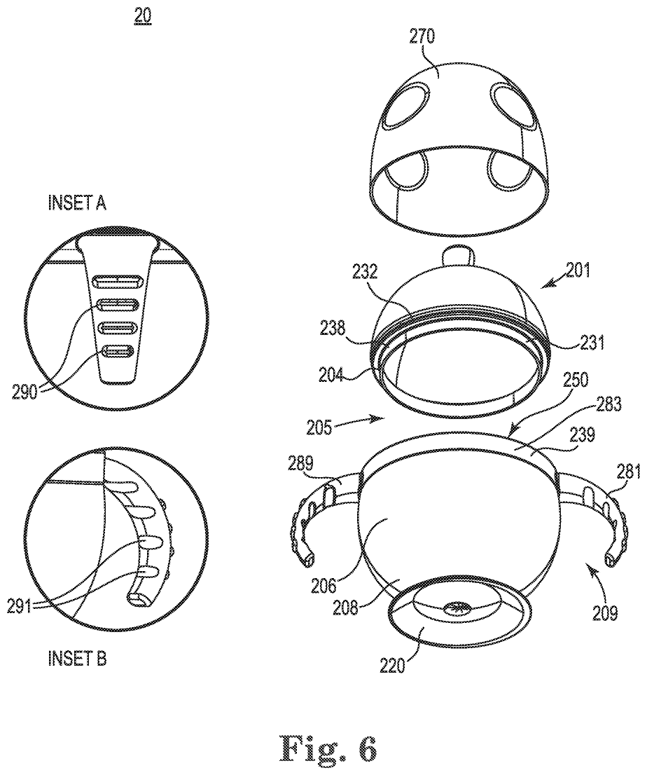

In this example the connector assemblies and handles form a handle assembly 250. In this example embodiment, and with reference to Inset A and Inset B of FIG. 6, each of the handle members 281 and 289 include one or more textured frictional elements 290 disposed thereon to enhance gripping by an infant. In a related embodiment, each of the handle members 281 and 289 include one or more textured frictional elements 291 disposed on an interior surface of the handles thereon to enhance gripping by an infant. In this example embodiment, the right-side handle member and a left-side handle member of the handle assembly are of a semi-circular or C-shaped configuration. The textured frictional elements are selected from a group consisting of a plurality of fins, a plurality of nubs, and a plurality of microparticles. In a related embodiment, the handle assembly 250 is formed from a plastic material impregnated with a luminescent material to enhance low light visibility for infant or caregiver.

In yet another related embodiment, the upper ball member 201 includes a two-member structure comprised of the silicone areola-emulating portion and the nipple-emulating portion as a first member and a polymer dome structure having upper and lower openings as a second member, wherein the areola-emulating and nipple-emulating portions are removably disposed within the upper opening of the dome structure.

A stand assembly 220 is coupled to a base 208 of the lower portion 209 of the silicone ball member 200. In one embodiment, the stand assembly 120 is substantially cylindrical and may be a suction cup. In related embodiments, stand assembly 220 is selected from the group consisting of a suction cup configuration, a rubber-coated weight disk or plate, and an assembly including a plurality of legs or pegs that support the infant bottle.

This embodiment may have a cap member or cover 270 to cover the upper ball portion 201 of the silicone ball member 200, and a right-side handle member 281 and a left-side handle member 289 are coupled to a ring member 283 of the lower helically threaded, plastic connector assembly 239. In various example embodiments, cover member 270 is formed from one of a transparent and translucent material. At least one hole member 263 (optionally it can include more holes for faster drinking) is disposed through the proximal end 261 of the nipple portion 260, the silicone ball member 200 designed to hold and dispense a liquid through the proximal end 261 of the nipple portion 260 therethrough.

In yet another related embodiment, an infant feeding bottle is provided that includes a substantially spherical ball member with a hollow interior portion or cavity, wherein the spherical ball member is laterally divided at a horizontal plane located at or near a middle portion of the spherical ball member thereby forming at least two separable portions that include an upper ball portion 201 and a lower ball portion 209, each of the two separable ball portions designed to be coupled to each other via respective helically threaded male and female elements at a middle portion 205. Further included is a substantially circular, areola-emulating portion 240 disposed or formed on the upper spherical ball portion 201, the areola-emulating portion including a plurality of protrusion members 242 disposed within the substantially circular, areola emulating portion 240, wherein the horizontal plane (similar to 105 in FIG. 1) is substantially coplanar to the substantially circular, areola emulating, portion. The infant bottle further includes a nipple-emulating member 260 substantially centering the substantially circular, areola emulating portion and having proximal and distal ends, the nipple emulating member having a substantially cylindrical configuration with the distal end coupled to and protruding longitudinally up from the areola emulating portion, such that the nipple portion includes a least one self-closing hole 263 at the proximal end adapted to dispense a fluid located within the cavity 201 and 209. There is also included a stand assembly 220 coupled to or in contact with a base of the lower portion 209 of the spherical ball member 200, and a handle assembly including a ring member 283 supporting a right-side handle member 281 and a left-side handle member 289, the handle assembly 250 coupled to the lower helically threaded portion.

In a related embodiment of the infant bottle, the spherical ball member is comprised of an upper silicone ball portion including the areola emulating portion and a lower plastic portion including the stand assembly, the upper silicone ball portion further including an upper helically threaded rim member designed to couple to a lower helically threaded, plastic connector assembly located on the lower plastic portion at the middle portion. The infant bottle of claim 6 further including a cover member adapted to enclose the nipple emulating portion and the areola-emulating portion of the spherical ball portion, In this example embodiment the upper and lower helically threaded plastic connector assemblies contiguously coupled to respective upper and lower edge portions of the middle portion, with corresponding groove and ridge or rim portions of the upper and lower helically threaded, plastic connector assemblies, when in a coupled state, substantially contiguously meshed.

In related embodiments of the infant bottle, there is included a loop protrusion member is disposed on the spherical ball portion laterally away from the cylindrical nipple emulating member, such that the loop protrusion member facilitates temporary fastening of infant bottle an infant or a caregiver. In yet another related embodiment, the infant bottle includes at least one of the silicone ball portion, nipple member or areola emulating portion that is impregnated with an antimicrobial substance.

For purposes of the embodiments described herein, the term plastic includes but is not limited to Polyethylene terephthalate (PET or PETE), high-density polyethylene (HDPE), Polyvinyl chloride (PVC) and other polymers. Although the primary material for the spherical ball member and portion is silicone, other related flexible materials such as rubber or latex can be used as well as implantable medical device materials that are compatible to silicone. Antimicrobial coatings similar to the those used in implantable medical devices can also be used to coat the spherical ball member, particularly one made from silicone.

The following patents are incorporated by reference in their entireties: U.S. Pat. Nos. 6,253,935; 11,033,462; 20020026218A1, and 20120160897A1.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An anatomically emulating infant pacifier for a sucking infant's mouth comprising:
a substantially spherical, silicone ball member with a hollow interior portion or cavity, wherein the cavity is filled with a predetermined amount of one of either a gas or liquid and is hermetically sealed to retain the gas or liquid;
a substantially circular, areola emulating, portion disposed or formed on the silicone ball member, the areola-emulating portion including a plurality of protrusion members disposed within the substantially circular, areola emulating portion; and
a nipple emulating member substantially centering the substantially circular, areola emulating portion and having proximal and distal ends, the nipple emulating member having a substantially cylindrical configuration with the distal end coupled to and protruding longitudinally up from the areola emulating portion;
wherein the hollow interior portion of the silicone ball member is adapted to equalize to a prevalent gas pressure such that the silicone ball member is squeezable by the infant to emulate the feel of a human breast.

2. The infant pacifier of claim 1 wherein the gas is air.

3. The infant pacifier of claim 1 wherein the liquid is selected from the group consisting of water and saline.

4. The infant pacifier of claim 1 wherein at least one of the silicone ball member, nipple member or areola emulating portion is impregnated with an antimicrobial substance.

5. The infant pacifier of claim 1 wherein the nipple-emulating member has a substantial hourglass configuration, the proximal end of the nipple emulating member having a diameter substantially equivalent from the distal end of the nipple emulating member, the middle portion of the nipple emulating member narrower than the distal and proximal ends of the nipple emulating member.

6. An infant feeding bottle comprising:
a substantially spherical ball member with a hollow interior portion or cavity, wherein the spherical ball member is laterally divided at a horizontal plane located at or near a middle portion of the spherical ball member thereby forming at least two separable portions that include an upper ball portion and a lower ball portion, each of the two separable ball portions adapted to be coupled to each other via respective helically threaded male and female elements at a middle portion;
a substantially circular, areola-emulating portion disposed or formed on the upper spherical ball portion, the areola-emulating portion including a plurality of protrusion members disposed within the substantially circular, areola emulating portion, wherein the horizontal plane is substantially coplanar to the substantially circular, areola emulating, portion; and
a nipple-emulating member substantially centering the substantially circular, areola emulating portion and having proximal and distal ends, the nipple emulating member having a substantially cylindrical configuration with the distal end coupled to and protruding longitudinally up from the areola emulating portion, wherein the nipple portion includes a least one self-closing hole at the proximal end adapted to dispense a fluid located within the cavity;
a stand assembly coupled to or in contact with a base of the lower portion of the spherical ball member; and
a handle assembly including a ring member supporting a right-side handle member and a left-side handle member, the handle assembly coupled to the lower helically threaded portion.

7. The infant bottle of claim 6 wherein the spherical ball member is comprised of an upper silicone ball portion including the areola emulating portion and a lower plastic portion including the stand assembly, the upper silicone ball portion further including an upper helically threaded rim member adapted to couple to a lower helically threaded, plastic connector assembly located on the lower plastic portion at the middle portion.

8. The infant bottle of claim 6 further including a cover member adapted to enclose the nipple emulating portion and the areola-emulating portion of the spherical ball portion, wherein the cover member is formed from one of a transparent and translucent material.

9. The infant bottle of claim 7 wherein the upper and lower helically threaded plastic connector assemblies contiguously coupled to respective upper and lower edge portions of the middle portion, with corresponding groove and ridge or rim portions of the upper and lower helically threaded, plastic connector assemblies, when in a coupled state, substantially contiguously meshed.

10. The infant bottle of claim 6 further including a loop protrusion member is disposed on the spherical ball portion laterally away from the cylindrical nipple emulating member, wherein the loop protrusion member facilitates temporary fastening of infant bottle an infant or a caregiver.

11. The infant bottle of claim 7 wherein at least one of the silicone ball portion, nipple member or areola emulating portion is impregnated with an antimicrobial substance.

12. The infant bottle of claim 6 wherein the right-side handle member and a left-side handle member of the handle assembly are of a semi-circular or C-shaped configuration.

13. The infant bottle of claim 12 wherein the handle assembly is formed from a plastic material impregnated with a luminescent material to enhance low light visibility.

14. The infant pacifier of claim 1 further including a loop protrusion member is disposed on the silicone ball member laterally away from the cylindrical nipple emulating member, wherein the loop protrusion member facilitates temporary fastening of infant pacifier to one of an infant or a caregiver.

15. The infant pacifier of claim 1 further including a loop protrusion member is disposed on the silicone ball member substantially opposite of the cylindrical nipple emulating member, wherein the loop protrusion member facilitates temporary fastening of infant pacifier to one of an infant or a caregiver.

16. The infant bottle of claim 12 wherein each of the handle members include one or more textured frictional elements disposed thereon to enhance gripping by an infant.

17. The infant bottle of claim 16 wherein the textured frictional elements are selected from a group consisting of a plurality of fins, a plurality of nubs, and a plurality of microparticles.

18. The infant bottle of claim 6 wherein the stand assembly is selected from the group consisting of a suction cup configuration, a rubber-coated weight disk or plate, an assembly including a plurality of legs or pegs that support the infant bottle.

19. The infant pacifier of claim 1 wherein the silicone ball member includes a plurality of textured frictional elements disposed on a surface to enhance gripping by the infant.

20. The infant bottle of claim 6 wherein the upper ball member includes a two-member structure comprised of the silicone areola-emulating portion and the nipple-emulating portion as a first member and a polymer dome structure having upper and lower openings as a second member, wherein the areola-emulating and nipple-emulating portions are removably disposed within the upper opening of the dome structure.
